(19) United States
(12) Patent Application Publication
(10) Pub. No.: US 2013/0316054 A1
(43) Pub. Date: Nov. 28, 2013

(54) METHOD FOR PRESERVING ORGANIC PIECE GOODS AND METHOD FOR PRODUCING PRESERVED ORGANIC PIECE GOODS

(71) Applicant: Jens Wolfram, Erfurt (DE)

(72) Inventor: Jens Wolfram, Erfurt (DE)

(73) Assignee: INNODRYING GmbH, Barleben (DE)

(21) Appl. No.: 13/510,121

(22) PCT Filed: Nov. 17, 2010
(86) PCT No.: PCT/DE2010/001340

§ 371 Date: May 14, 2013

(30) Foreign Application Priority Data
Nov. 17, 2009 (DE) 10 2009 055 809.8

(51) Int. Cl. A23L 3/42; A23B 7/022; A23B 4/033

(52) U.S. Cl. CPC A23L 3/42; A23B 4/033; A23B 7/022
USPC 426/332; 426/321

(57) ABSTRACT

A method for preserving organic piece goods, for example, foods such as fruits, plants, parts thereof, small animals, and animal piece goods, and organic piece goods from the non-food sector, for example, cut flowers, using a dehydrating solvent and by drying in a drying device, and a for producing preserved organic piece goods involves drying the piece goods are dried in a drying device in the presence of the solvent at temperatures below 100° C., preferably in a fluidized bed. The procedure has the advantage of significantly lower drying temperatures compared to freeze drying, requiring substantially shorter drying times, and thus having significantly better energy efficiency, and being more environmentally friendly. The drying procedure is gentle, wherein the organic piece goods substantially retain the original shape, color, and contents thereof.

The invention proceeds from a method for the preservation of organic piece goods, for example foods such as fruits, plants, as well as parts of these, tiny animals and animal piece goods, but also of organic piece goods from the non-food sector, for example cut flowers, in accordance with the preamble of claim 1, as well as to a method for the production of preserved organic piece goods, in accordance with the preamble of claim 14.

A proven method for preserving organic material is to dry it, in other words to remove water from the piece goods. While the important thing in the case of organic material from the non-food sector is merely to maintain the color and shape of the organic material, for example of cut flowers, in the case of foods care must also be taken to ensure that the taste is maintained, along with the other components that are important for nutrition physiology, such as, for example, the vitamins.

The drying methods most frequently used for foods include freeze-drying, fluidized bed drying, spray-drying, and normal drying in drying apparatuses or solely with the use of solar energy.

In the case of fluidized bed drying, the goods to be dried are fluidized, i.e. dried in an eddy of air. The disadvantage of this method consists in that because of the relatively high temperatures that are required, generally far above 100° C., foods lose not only their natural appearance, but also their ingredients. As a result, use of fluidized bed drying is limited to those products that are not damaged by high temperatures, for example sugar, or foods whose preparation requires entirely higher temperatures, as is the case for coffee roasting.

Spray-drying is only suitable for the production of powdered material, such as milk powder, for example.

Aside from sun drying, which is a very time-consuming process and therefore can also be used only for a few products, the principle of the other drying methods based on removal of water by means of heat consists in evaporating the water as quickly as possible. As a result, the natural appearance and, in the case of foods, their entire ingredients are lost.

The gentlest methods for foods, to maintain their taste, their appearance, and also their ingredients that are important for nutrition physiology, to the greatest possible extent, is freeze-drying. In this process, which is widespread in the foods and pharmaceutical industry, the water is withdrawn from the organic material by means of sublimation. For this purpose, the organic material is heated, so that the water can exit from the cell walls in the form of ice vapor. At the same time, the surroundings of the material are super-cooled, in such a manner that the water that exits crystallizes immediately and deposits on the cooling surfaces. This process requires a lot of energy, because two opposite processes counteract one another, namely heating and freezing. Furthermore, the drying period of this process is very long; for example, 24 to 48 hours are required for drying fruit, depending on the type and size of fruit. Because of the long drying times, the quantitative yield of the process is not very great. Furthermore, freeze-drying requires complicated systems technology. All these disadvantages make this method expensive, and this is also expressed in a correspondingly high end product price. Finally, it must also be mentioned as a disadvantage that freeze-drying is not suitable for particularly sensitive foods, such as mushrooms.

Finally, a method for preservation of a granulated starch that has not been pre-gelatinized or a granulated flour that has not been pre-gelatinized is known, in which the starch or the flour is dehydrated until the starch or the flour, respectively, is water-free or almost water-free. Subsequently, the dehydrated starch or the dehydrated flour is dried at temperatures of 100° C. or above. A hydrophilic solvent, for example alcohol, is used in the case of non-thermal dehydration. The subsequent drying can take place in a fluidized bed reactor and lasts 1 to 20 hours, depending on the desired degree of inhibition (U.S. Pat. No. 5,932,017 A). The disadvantage of this method consists in that it can be used only for starch and flour, not for the products themselves, from which the starch or the flour is obtained. Furthermore, in the case of the high drying temperatures, the products would undergo disadvantageous changes both in terms of their appearance and in terms of their ingredients, as has already been mentioned above.

### THE INVENTION AND ITS ADVANTAGES

The method according to the invention, having the characteristics of the main claim, as well as of claim 14, has the advantage that it makes do with clearly lower drying temperatures and requires significantly shorter drying times than freeze-drying. Comparable amounts, which required 24 to 48 hours with freeze-drying, can be dried in 30 to 90 minutes by means of the method according to the invention. Therefore greater throughput can also be achieved.

Because of the shorter drying times and because no processes that are energetically opposite take place in one and the same reactor, the method also demonstrates clearly better energy efficiency than freeze-drying, and is therefore more gentle on the environment than all methods known until now, aside from sun drying. The expensive cooling logistics that are required for freeze-drying are not needed for the method according to the invention. Cold is needed only for recovery of the solvent, but this can be implemented in simple manner and without complicated cooling technology, by means of known, so-called cold traps.

The third significant advantage that is achieved by means of the gentle drying process consists in the almost unlimited use of the preservation method. For example, sensitive plants, such as cut flowers, herbs, mushrooms, as well as soft fruits, such as berries, can be dried in such a manner that they keep their original shape, color, and also their ingredients, to a great extent, and do so despite the fact that the products have lost 92 to 99% of their liquid content after drying. This is achieved in that the cell structures of the organic dried goods are maintained by means of the presence of the dehydrating and, at the same time, also enriching solvent during the drying process in the fluidized bed. The ingredients lost by the organic material due to dehydration are returned to the cells, which are almost free of water, by way of the solvent. For example, drying whole strawberries is possible, something that does not make sense using the freeze-drying method, for economic reasons, because any increase by 0.5 cm in the diameter of the fruit to be dried is accompanied by a squared lengthening of the drying time. The end products are furthermore germ-reduced, by means of extensive elimination of harmful agents such as fungi, bacteria, and others, for example.

According to an advantageous embodiment of the invention, the organic piece goods are dried in a fluidized bed. In the fluidized state, an ideal transfer of heat and substances is possible, so that the drying time of the piece goods is further reduced.

According to an embodiment of the invention that is advantageous in this regard, drying of the organic piece goods takes place in the fluidized bed under vacuum, thereby significantly accelerating the processes of the transfer of heat and substances.

According to another embodiment of the invention, in this regard, drying of the organic piece goods takes place in the fluidized bed under normal pressure, as convective drying.

According to another advantageous embodiment of the invention, the solvent is recovered from the waste air stream of the drying apparatus. The recovered solvent can be used for pretreatment of the piece goods with solvent, as is explained in the next paragraph, or can be returned to the piece goods during the drying process, in the enrichment phase. The preservation method gains significantly in efficiency by means of circulation of the solvent.

According to an additional advantageous embodiment of the invention, the organic piece goods are brought into contact with the solvent before being introduced into the drying apparatus. As a result, dehydration, during which the water-soluble ingredients of the organic piece goods get into the solvent and can be returned to the piece goods during the enrichment phase of the drying process, in an advantageous embodiment of the invention in this regard, already takes place before the drying process. By means of being embedded in a solvent, the organic piece goods can be stored over a longer period of time without spoiling or losing its ingredients. Final preservation of the product in question by means of drying is then undertaken in accordance with the capacity of the drying system or as needed, whereby its ingredients are returned to the product during the drying process, by way of the solvent in which it was embedded.

Use of the solvent that was previously in contact with the piece goods to be dried and extracted their ingredients from them to enrich the organic piece goods has the advantage that the piece goods are given back their original ingredients, to a great extent, something that is of particular importance for foods, last but not least, also from the aspect of nutrition physiology.

On the other hand, however, it is also possible to supply the organic piece goods situated in the drying apparatus with a solvent that has been enriched in another way, in order to reinforce specific properties or to achieve other special properties of the finished product.

According to a particularly advantageous embodiment of the invention, the solvent is applied to the organic piece goods after they have been pre-dried. As a result, the ingredients transported with the solvent can immediately be taken up by the cells of the goods, and the solvent, which has now been discharged, can leave the drying apparatus together with the exhaust air.

This advantage is further reinforced if the solvent is preheated before being applied to the organic piece goods.

Another possibility for preserving the organic piece goods to be dried for a certain period of time before drying consists in freezing them, for example by means of shock-freezing. This is particularly necessary for those foods that must travel a longer distance to the drying system, or, as is the case for seafood, must remain on the ship for an extended period of time after being caught.

According to another advantageous embodiment of the invention, the organic piece goods are subjected to a permeation process after drying. For this purpose, the organic piece goods are brought into contact with an agent, for example paraffins, silicone, or the like, which stabilizes the cell walls of the piece goods in such a manner that they maintain their original shape. This subsequent treatment will particularly find use for such organic products in which the optical impression is particularly important, for example in the case of cut flowers or organic preparations that serve as displays.

Further advantages and advantageous embodiments of the invention can be derived from the following description, the drawing, and the claims.

### DRAWING

An exemplary embodiment of the invention is shown in the drawing and described in greater detail below. The drawing shows:

FIG. 1 the flow schematic of a variant of the method according to the invention, with pretreated organic piece goods under vacuum or as a nitrogen process, and

FIG. 2 the flow schematic for the variant without pretreatment of the piece goods, also under vacuum or as a nitrogen process.

### DESCRIPTION OF THE EXEMPLARY EMBODIMENT

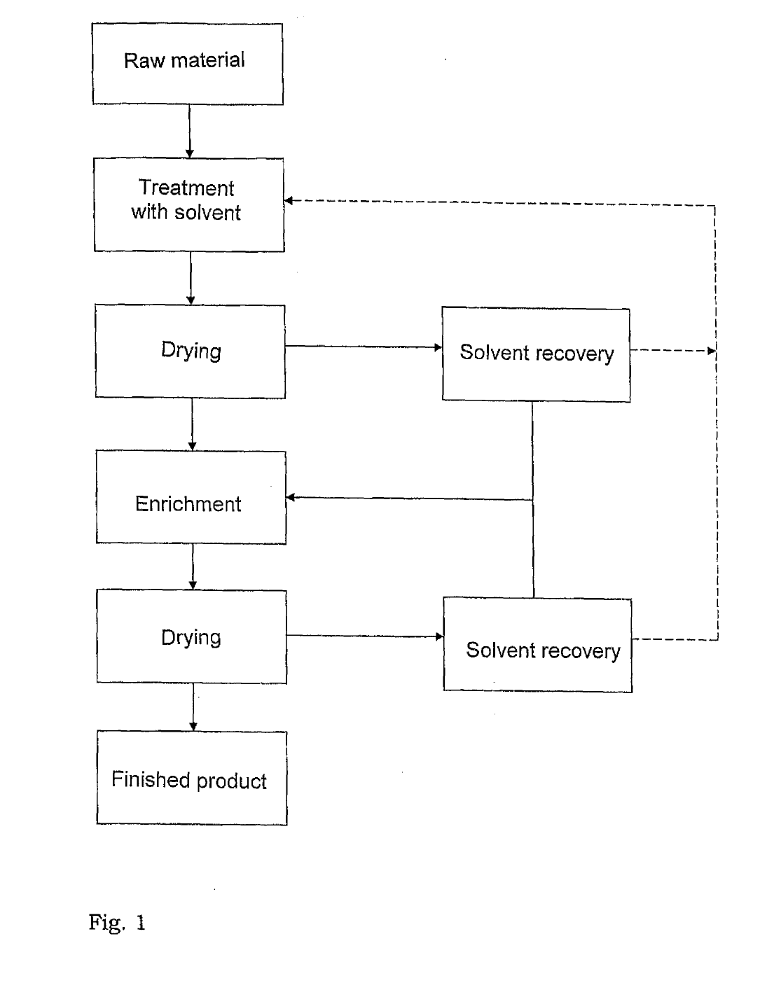

According to the flow schematic from FIG. 1, organic material is made available as fresh raw material, washed, and chopped to the desired piece goods size, if necessary. In the second step, it is brought into contact with a solvent that has a density less than that of water. Depending on the period of action, part or all of the moisture is extracted from the raw material by the solvent. Subsequently, the solvent is separated from the piece goods and the piece goods are dried in a fluidized bed apparatus. Pre-drying takes place first, in which the solvent evaporates and leaves the drying apparatus with the exhaust air. Subsequently, the ingredients that were previously extracted from the goods to be dried by the solvent are returned to the goods to be dried, in that the goods goods to be dried are sprayed with the solvent enriched with these ingredients, during the drying process. The excess solvent is recovered from the waste air stream of the drying process and reused, so that it can be passed back to the piece goods before and/or during the drying process. The drying process can take place both in a vacuum and under an inert gas atmosphere, for example using nitrogen.

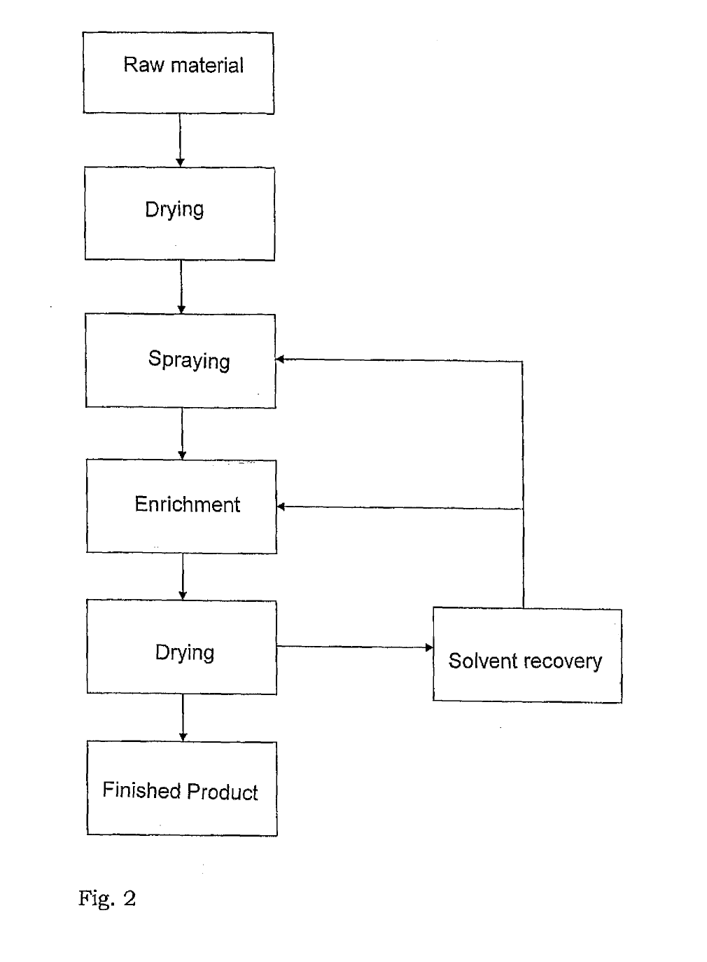

The flow schematic shown in FIG. 2 differs from the one in FIG. 1 only in that treatment of the organic piece goods with solvent before the drying process is eliminated, the raw material is therefore introduced into the drying apparatus with its original moisture content, and extraction of the water takes place exclusively in the drying apparatus. Here again, pre-drying takes place first. The solvent that is sprayed in afterward supports the thermal extraction of water, in that it rapidly penetrates into the cells and takes bound water with it when it exits. During this process, which takes place within a very short time interval, approximately 70% of the ingredients remain in the organic material. It is true that this result is also achieved in the case of freeze-drying, but this process requires a multiple of time and energy for this purpose, as has already been mentioned. However, the method according to the invention furthermore allows returning the 30% of the ingredients that have been lost as the result of the drying process to the product, in that the goods to be dried are sprayed, for a short period of time, with a solvent that has been enriched with the ingredients, in a next step. After this so-called enrichment process, the organic piece goods are dried in a last drying step, to finish drying them, whereby here, too, the solvent is recovered.

In the following, the method according to the invention will be explained in greater detail using drying of a concrete product:

50 kg parsley are chopped into small pieces and placed in alcohol. After an action period of 24 hours, the remaining solvent, which has now been enriched both with the pigment and with the other water-soluble ingredients, is removed. The chopped parsley is filled into a vacuum fluidized bed reactor and pre-dried with an air amount of 4,000 m³/h. The entry temperature of the air into the fluidized bed reactor is 70° C.; its exit temperature is 12 to 30° C. The vacuum pressure amounts to 220 mbar. The alcohol contained in the waste air stream is recovered in liquid form by way of a cold trap. After a pre-drying time of 30 min, the enrichment process of the parsley with the pigment and flavor substances previously extracted by the alcohol takes place. For this purpose, enriched alcohol is sprayed onto the chopped parsley, which continues to be in the fluidized state, at a spray pressure of 20 bar, specifically the alcohol obtained from the initial pickling process of the parsley. While maintaining the vacuum pressure of 220 mbar, the air amount is reduced to 3,000 m³/h. The spray period amounts to 25 min. Afterward, a final drying process of 30 minutes follows, while maintaining the parameters from the pre-drying process. The finished product that leaves the fluidized bed reactor now has only a residual moisture content of 4%.

All of the characteristics shown in the specification, the following claims, and the drawing can be essential to the invention both individually and in any desired combination with one another.

1-15. (canceled)

16: A method for the preservation of organic piece goods including fruits, plants, parts of these, and animal piece goods, comprising:
drying the piece goods with the use of a dehydrating solvent in a drying apparatus at temperatures below 100° C., and
supplying an enriched solvent to the organic piece goods.

17: The method according to claim 16, wherein the enriched solvent is enriched with ingredients previously extracted from the organic piece goods.

18: The method according to claim 16, wherein the organic piece goods are brought into contact with the dehydrating solvent before being introduced into the drying apparatus.

19: The method according to claim 16, wherein the solvent that was in contact with the piece goods to be dried, before drying, is used as the enriched solvent.

20: The method according to claim 16, wherein the organic piece goods are dried in a fluidized bed.

21: The method according to claim 19, wherein drying of the organic piece goods takes place in a fluidized bed, under vacuum.

22: The method according to claim 19, wherein drying of the organic piece goods takes place in a fluidized bed, under normal pressure.

23: The method according to claim 16, wherein the solvent is recovered from a waste air stream of the drying apparatus.

24: The method according to claim 23, wherein the recovered solvent is returned to the organic piece goods that are situated in the drying apparatus.

25: The method according to claim 16, wherein the enriched solvent is applied to the organic piece goods after pre-drying of the organic piece goods.

26: Method according to claim 16, wherein the dehydrating solvent is preheated before being applied to the organic piece goods.

27: Method according to claim 16, wherein the organic piece goods are subjected to a permeation process after drying.

28: A method for the production of preserved organic piece goods including preserved fruits, plants, parts of these, or animal piece goods, comprising the steps of:
drying the piece goods with the use of a dehydrating solvent in a drying apparatus at temperatures below 100° C., and
supplying an enriched solvent to the organic piece goods.

29: The method according to claim 28, wherein the enriched solvent is enriched with ingredients previously extracted from the organic piece goods.
